(19) United States
(12) Patent Application Publication
(10) Pub. No.: US 2015/0205016 A1
(43) Pub. Date: Jul. 23, 2015

(54) Optical system for producing a specific light distribution

(71) Applicant: Karl Jungbecker GmbH & Co., Olpe (DE)

(72) Inventor: Andreas Hesse, Wenden-Gerlingen (DE)

(21) Appl. No.: 14/598,404

(22) Filed: Jan. 16, 2015

(30) Foreign Application Priority Data
Jan. 17, 2014 (DE) 10 2014 100 520.1

(51) Int. Cl. G02B 5/02

(52) U.S. Cl. CPC G02B 5/0294

(57) ABSTRACT

The invention relates to an optical system (1) for producing a specific light distribution, in particular an asymmetrical light distribution for glare limitation, the system comprising an optically effective plate (10, 210, 310) whose one main surface (11, 12, 211, 212) is formed as a light entering surface and whose other main surface (11, 12, 211, 212) is formed as a light emergent surface, a planar diffuser structure (20, 220, 320) in a tabular form or in the form of a foil extending in front of the light entering surface of the first plate (10, 210, 310) in the light direction. The the planar diffuser structure (20, 220, 320) is mechanically connected to the first plate (10, 210, 310) in the region of predetermined mounting portions and is arranged so as to be spaced from the first plate (10, 210, 310) over a major part of its area extent.

The invention relates to an optical system for producing specific light distributions, in particular an asymmetrical light distribution, for lighting objects or for limiting glare, the system comprising an optically effective first plate whose one main surface is constructed as the light entering surface and whose other main surface is constructed as the light emergent surface, a planar diffuser structure in a tabular form or in the form of a foil extending in front of or behind the light entering surface in the lighting direction.

Such optical systems are frequently used in the display and lighting technology, for instance to homogenize the light from point light sources and, depending on the specific application, to produce a predetermined light distribution and glare limitation, a Batwing light distribution or a different asymmetrical or symmetrical angular distribution. To this end, the conventional optical systems comprise at least two optically effective planar structures arranged on top of each other such as plates, sheets and/or films that are each designed for a predetermined change of the light distribution. In the display and lighting field, said optically effective planar structures are held in a predetermined position within the lighting unit or display by means of associated holding structures. Depending on the thickness and the number of planar structures arranged on top of each other, the installation and fixing of the optical system in the display or lighting unit is complicated and laborious and often requires manual work.

The invention is based on the object of simplifying the use and reducing the cost of installing the optical systems in displays and/or lighting units while maintaining or even extending the high optical functionality of conventional optical systems.

According to the invention, this object is already achieved by an optical system for producing a specific light distribution including the features of claim 1. The system of the invention is characterized in that the planar diffuser structure is mechanically connected to the first plate in the region of predetermined mounting portions and is disposed in such a manner as to be spaced from the first plate over the major part of its area extent. By the described constructional measure of the optical system of the invention it is achieved on the one hand that the system can be installed in displays or lighting units as a single component, thereby reducing time and labor for mechanical mounting and fixing. Additionally, it is achieved by the described constructional measure that the optical power of said two planar structures for directing and distributing light is not disturbed by the adjacent structure over the major part of the overlapping region of the diffuser structure and the first plate.

Preferably, both the diffuser structure and the first plate can be made of or comprise any optically effective and preferably easy processing material such as an optical synthetic material, e.g. PMMA, PVC or polycarbonate.

Advantageous further developments of the invention will become apparent from the following general description, the detailed description and the subclaims.

Advantageously, a fluid gap, in particular an air gap, may exist between the diffuser structure and the first plate in order to provide for predetermined and defined refractive index transitions between the optically effective structures and hence for a predetermined exact light routing. To provide these optical properties irrespective of external conditions and over an extended period of time, the fluid can be preferably enclosed between the first plate and the diffuser structure, particularly in an airtight, dustproof, moisture-tight and/or gas-tight manner. Thus particles or substances for example are prevented from penetrating into the intermediate space between the diffuser structure and the first plate, which would otherwise disturb light routing or would be optically distinguishable as an undesired irregularity.

A particularly advantageous configuration can be obtained when the diffuser structure and the first plate are not spaced alone and only in the mounting portions in which both components are connected to each other. A particularly useful and advantageous embodiment is obtained when the diffuser structure is connected to the first plate merely at its boundary edges so that a distance exists over the whole overlapping region of the diffuser structure and the first plate. Insofar, the optimal optical properties of both components can be provided in such a system over the whole area extent of the diffuser structure and/or the first plate.

To guarantee the effect of the decoupling between the light routing and the individual plates, the distance between the diffuser structure and the first plate should reliably be larger than one μm. In particular embodiments, however, it can be provided that a larger distance is set, such as 50 μm or 100 μm.

The thickness of the foil, frequently of the diffuser structure, can most expediently be adapted to the optical power desired in each case and also to mechanical demands, which are a result of the respective use in the display or lighting technology. Normally, the planar diffuser structure can be comparatively thin with a thickness of <1 mm, particularly <350 μm or even less. Normally, the first plate can be thicker than the diffuser structure, for instance with a thickness of between 1 mm and 20 mm. Both the first plate and the diffuser structure can be designed in a dimensionally stable manner. Further, in certain applications, the diffuser structure can be in the form of a film or foil so that the same is not required to be dimensionally stable in all the embodiments. The term dimensionally stable describes the property of an object to keep a predetermined form of area or body without any external force effect, which is mostly not the case with a very thin foil.

Different designs are possible for producing a mechanical connection between the first plate and the planar diffuser structure and can also be specifically chosen for the respective material of the plate or the diffuser structure. When the connection is provided in the region of the boundary edges of the diffuser structure and/or the first plate, a plurality of form-locking connections such as a hook-type or claw-type engagement between the material of the plate and the diffuser structure can be provided. On the other hand, it is also possible to produce this connection by a material bond, for example by welding or gluing, particularly in the case of a mechanical coupling of the two components. Here attention should be paid that the planar diffuser structure and the first plate are in any case spaced from each other over a major part of the area extent of the diffuser structure, ideally over the whole area extent.

The optical system of the invention can be manufactured particularly easily by producing the mechanical connection between the first plate and the diffuser structure by laser or ultrasonic cutting of a stack arrangement of the corresponding semi-finished products of the first plate and the diffuser structure. It is possible for example to produce in the manner as described an optical system in which both the first plate and the diffuser structure are cut-out with the predetermined dimensions while simultaneously making the connection between the two components, particularly by producing a material bond at the boundary edges thereof.

Further, it can be provided for the planar diffuser structure to have a slight bulge so that an air gap is formed between the diffuser structure and the first plate in order to implement the desired geometrical, spaced arrangement of the diffuser structure to the first plate. It will be understood that this slight bulge can be as small as not being visible to the unaided eye, for forming an air gap over the major part of the area extent of the diffuser structure to the first plate. Here it may be particularly useful for this slight bulge on the planar diffuser structure being dome-shaped and the curvature of the diffuser structure extending towards the first plate so that the planar diffuser structure contacts the first plate alone by its boundary edges.

In a further embodiment it can also be provided for the arrangement of spacers for avoiding a full-area contact of the first plate and the planar diffuser structure. Preferably, these spacers can be integrally molded to a surface of the first plate and/or the diffuser structure so that both components contact each other in the region of the integrally molded spacers and are otherwise spaced from each other. These spacers can be provided for example in the form of mutually spaced parallel extending ridges on one surface of the first plate and/or the diffuser structure or also in the form of point-shaped elevations.

The mechanical connection between the first plate and the planar diffuser structure can be implemented in the region of respective contacting surfaces of the spacers when these spacers are provided. As far as a connection is provided at the boundary edges of the first plate or the diffuser structure, a connection at these contacting surfaces may be omitted.

The optical system of the invention is particularly suitable for designing a light distribution system for a display or lighting unit in which the light entering surface of the first plate is unstructured and the light emergent surface of the plate has an optically effective micro structuring for the defined light deflection of the light emerging from the first plate. Here the diffuser structure disposed in front of the first plate in the light direction can be constructed for scattering light emitted from an illuminant such as a plurality of point light sources.

The optical system of the invention is not limited to an arrangement of two optically effective planar structures behind each other. Instead it can be provided that the sequence of further optically effective planar structures is extended by the arrangement of additional foils, films and/or plates that each contribute to the desired specified total light distribution after passing the optical system, while planar structures arranged behind each other can be connected to each other in such a manner as to be handled in an easy manner as a single optical system, particularly for installing in a display or lighting unit.

Preferably, the connection of the optically effective planar structures into a single, easy-handling component can be configured as a permanent connection, i.e. one or more of the planar structures of the optical system are unable to be disconnected in a non-destructive manner.

Preferably, it can also be provided that on the main surface of the diffuser structure facing away from the first plate a second optically effective plate is arranged, the first and the second plates as well as the interposed diffuser structure being mechanically connected to each other in the region of mounting portions, particularly in the region the boundary edges thereof, a distance between the diffuser structure and the first plate and between the diffuser structure and the second plate being provided over the largest part of their respective area extent.

Incidentally, it can be provided that the mechanical connection between the first plate, the diffuser structure and the second plate is made by laser or ultrasonic cutting of a stack arrangement of semi-finished products such as a first base plate, a diffuser basic structure and a second base plate.

It should be pointed out to the fact that with an arrangement of more than two planar optically effective structures behind each other between adjacent structures also large-area connections, especially over the entire planar extension, are possible by gluing using transparent glue. Here it can be provided that the connection of the two planar structures by said transparent glue having a predetermined refractive index and these planar structures are matched in such manner that the desired optical property is achieved through the cooperation of both planar structures including the adhesive layer.

For adjusting the desired optical property of the diffuser structure, several designs may be conceived. It can be provided for example to dispose optically effective scattering particles within the planar diffuser structure, i.e. embedded in the volume. Additionally or alternatively it can also be useful to construct one or both main surfaces of the planar diffuser structure as an optically effective scattering surface.

Embodiments of the invention will now be described with reference to the attached drawings, wherein it is shown by:

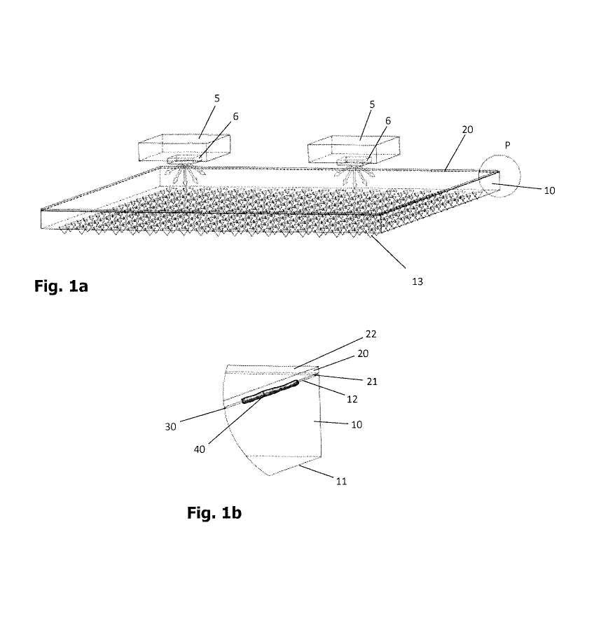

FIG. 1a an optical system constructed according to the invention together with irradiating LEDs, in a perspective view;

FIG. 1b a detailed view of the region P indicated in FIG. 1a;

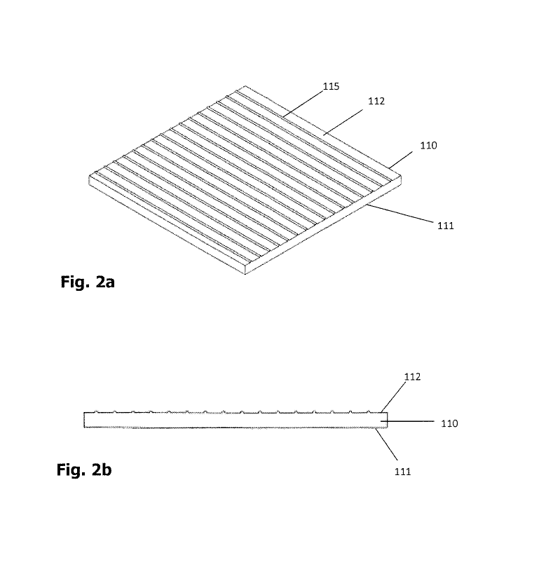

FIG. 2a a first plate of a different optical system constructed according to the invention, in a perspective view;

FIG. 2b the plate shown in FIG. 2a in a lateral view;

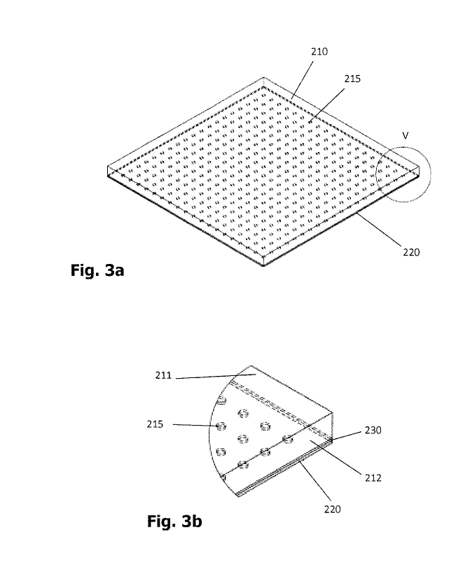

FIG. 3a a further embodiment of a first plate for an optical system constructed according to the invention, in a perspective view;

FIG. 3b a detailed view of the region V indicated in FIG. 3a; and

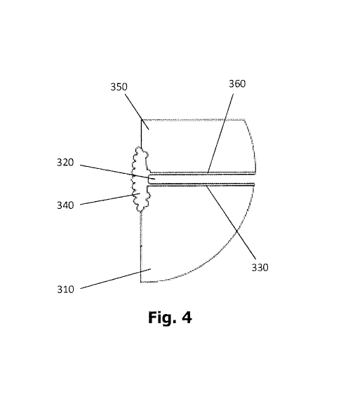

FIG. 4 a detail of a further embodiment of an optical system comprising a first and a second plate as well as a diffuser structure, in a lateral view.

FIG. 1a shows an optical system 1 of the invention together with a plurality of illuminants, the system 1 being arranged for transforming light emitted from the illuminants into light with a predetermined light distribution. To this end, the optical system 1 includes a a diffuser foil 20 as well as a first plate 10 arranged above each other. A detailed view of the region P indicated in FIG. 1a is shown in FIG. 1b. In the described embodiment, said two components of the optical system 1, i.e. the first plate 10 and the diffuser foil 20, are mechanically connected at the lateral edges thereof by material fusion 40, with the main surface 12 of the first plate 10 opposing the main surface 21 of the diffuser foil 20. In the described embodiment, the planar structures mechanically connected to each other by an adhesive bond present a continuous spacing of some μm, for example 5 μm. The diffuser foil 20 and the first plate 10 are connected to each other at all the boundary edges via material fusion 40 not illustrated in FIG. 1a and only partly illustrated in FIG. 1b.

The diffuser foil 20 is constructed for scattering incident light from the illuminants. To this end, it presents on both surfaces 21, 22 thereof microstructures in the form of scratches in the micrometer range. The light scattered from the diffuser foil is transmitted through the air gap 30 via the main surface 12 of the first plate into said first plate and is refracted in a defined manner at the light emergent surface, for forming a predetermined light distribution. To this end, microstructures in the form of refracting cones 13 arranged in a checkered pattern on the main surface that works as a light emergent surface are disposed on the main surface 12. For convenience of illustration, the refracting cones 13 molded to the light emergent surface 11 are not shown in FIG. 1b.

In the illustration according to FIG. 1a, the illuminant is provided by a plurality of LEDs 6 that are each arranged on an associated card 5 and substantially function as spotlights whose emitted light is scattered in a vast angular range through the diffuser foil 20.

As described, the light emitted from the LEDs is changed in its properties during the successive transmission through the diffuser foil 20 and the first plate 10, for producing the desired light distribution, for example a predetermined glare limitation, the optical properties of the diffuser film 20 and the first plate 10 being matched.

In the described embodiment, both the first plate 10 and the diffuser foil 20 are made of PMMA. The thickness of the diffuser foil 20 amounts to 100 μm, the thickness of the first plate 10 amounts to 10 mm.

The optical system 1a shown in FIG. 1 can be manufactured for example by arranging a diffuser basic foil and a base plate on top of each other and by simultaneously cutting both components by laser, with the effect that during cutting said components are permanently connected to each other at their borders by an adhesive bond and/or in a form-locking manner through material fusion 40.

The spacing of the diffuser foil 20 and the first plate 10 can be obtained during the manufacturing process for example by permanently introducing a gas between the diffuser foil 20 and the first plate 10 during the cutting process. In a different embodiment it can also be provided that the diffuser structure 20 is formed thicker and with a very small bulge, for obtaining the described distance between the diffuser structure 20 and the first plate 10, ideally over the entire area extent of both components.

The FIGS. 2a and 2b show the structure of a first plate 110 in a further embodiment of an optical system according to the invention, in which cylindrical ridges 115 spaced on the main surface 112 and arranged parallel to one edge of the plate are integrally molded for providing spacers to the diffusor foil (not illustrated). The arrangement of such ridges guarantees that an air gap exists over the major part of the planar extension of the adjacent components, i.e. the diffuser foil 20 and the first plate 10, so that the respective optical properties of the diffuser foil 20 or the first plate 10 do not interfere. In the embodiment of a first plate shown in the FIGS. 2a, b, the main surface 111 is unstructured and is designed as a plane surface.

Normally, the spacers are integrally arranged on the plate 10. In a different embodiment, not illustrated, the spacers can however be provided also on the diffuser structure. Even in an optical system of such kind, the mechanical connection of the diffuser structure 20 and the first plate 10 can be produced by cutting and by a simultaneous connection at the cutting edges.

A further embodiment of an optical system 1 constructed according to the invention is shown by the FIGS. 3a and 3b. The plate 210 has burl-like structures in the form of cylindrical protrusions 215 on the main surface 212 facing the diffuser foil 220. These protrusions 215 provide for the described distance between the diffuser structure 220 and the first plate 210. FIG. 3a shows the region V indicated in FIG. 3a in a detailed view. The gap 230 is determined by the height of the cylindrical protrusions 215. The material fusion on the rims of the first plate 210 and of the diffuser foil 220 described in the above embodiments and also provided in the present embodiment and caused by the above-described simultaneous cutting of the components is not illustrated here for the sake of simplicity.

The optical system 1 according to the invention is not limited to the connection of only two planar, optically effective structures. FIG. 4 shows a lateral view of a detail of an embodiment in which the diffuser structure is arranged in the form of diffuser foil 320 in a sandwich-like manner between a first plate 310 and a second, optically effective plate 350, the diffuser foil 320 in the described embodiment including a gap 330 to the first plate 310 and a further gap 360 to the second optically effective plate 350. The sandwich structure is connected by cutting and fusing the individual components at their rim portions also in this embodiment, the fusion 340 representing a material bond between said three components at their boundary edges.

In an embodiment which is not illustrated, particularly in case where the individual planar components are not made of a similar optical material or where specific process parameters are set during cutting, a mechanical connection at the boundary edges between the individual components can be obtained which is not based on a material bond, but instead on a form-locking connection by a hook-type or claw-type engagement of fused subareas of the individual planar components of the optical system 1 of the invention.

### LIST OF REFERENCE NUMBERS

1 optical system
5 card
6 LEDs
10 first plate
11, 12 main surface
13 refraction cone
20 diffuser foil
21, 22 main surface
30 gap
40 material fusion
110 first plate
111, 112 main surface
115 ridge
210 first plate
211, 212 main surface
215 cylindrical protrusion
220 diffuser foil
230 gap
240 material fusion
310 first plate
320 diffuser foil
330 gap
340 material fusion
350 second plate
360 gap

1. Optical system for producing a specific light distribution, in particular an asymmetrical light distribution for glare limitation, the system comprising an optically effective plate whose one main surface is formed as a light entering surface and whose other main surface is formed as a light emergent surface, a planar diffuser structure in a tabular form or in the form of a foil extending in front of the light entering surface of the first plate in the light direction,
characterized in that the planar diffuser structure is mechanically connected to the first plate in the region of predetermined mounting portions and is arranged so as to be spaced from the first plate over a major part of its area extent.

2. Optical system according to claim 1,
characterized in that a fluid gap, in particular an air gap, is arranged between the diffuser structure and the first plate.

3. Optical system according to claim 1,
characterized in that the diffuser structure is arranged so as to be spaced from the first plate, with the exception of the region of its mounting portions and particularly with the exception of the region of its boundary edges.

4. Optical system according to claim 1,
characterized in that the distance between the diffuser structure and the first plate is less than 25 μm, in particular less than 5 μm.

5. Optical system according to claim 1,
characterized in that a gaseous fluid is enclosed between the first plate and the diffuser structure in a dustproof, moisture-tight and/or gas-tight manner.

6. Optical system according to claim 1,
characterized in that the planar diffuser structure has a thickness less than 250 μm, in particular less than 75 μm.

7. Optical system according to claim 1,
characterized in that the mechanical connection between the first plate and the diffuser structure is implemented by the formation of a plurality of form-locking connections, particular by a hook-type or claw-type engagement.

8. Optical system according to claim 1,
characterized in that the mechanical connection between the first plate and the diffuser structure is produced by laser or ultrasonic cutting of a stack arrangement of a first base plate and of a diffuser basic structure such as a diffuser foil.

9. Optical system according to claim 1,
characterized in that spacers are provided for avoiding a full-area contact of the first plate and the diffuser structure.

10. Optical system according to claim 9,
characterized in that the spacers are integrally molded to a surface of the first plate and/or the diffuser structure.

11. Optical system according to claim 9,
characterized in that the first plate and the diffuser structure are connected to each other in the region of the respective contact surfaces of the spacers.

12. Optical system according to claim 1,
characterized in that the light entering surface of the first plate is unstructured and/or the light emergent surface of the first plate includes an optically effective micro structuring for light-routing of the light emerging from the first plate.

13. Optical system according to claim 1,
characterized in that on the main surface of the diffuser structure pointing away from the first plate a second optically effective plate is disposed, the first and the second plates and the interposed diffuser structure being mechanically connected to each other in the region of mounting portions, in particular in the region of their boundary edges, a distance being provided between the diffuser structure and the first plate and between the diffuser structure and the second plate.

14. Optical system according to claim 13,
characterized in that the mechanical connection between the first plate, the diffuser structure and the second plate is produced by laser or ultrasonic cutting of a stack arrangement of a first base plate, a diffuser basic structure and a second base plate.

15. Optical system according to claim 1,
characterized in that the planar diffuser structure includes optically effective scattering particles embedded in the volume.

16. Optical system according to claim 1,
characterized in that at least one of the main surfaces of the planar diffusor structure is constructed as an optically effective scattering surface.
